(19) United States
(12) Patent Application Publication
(10) Pub. No.: US 2021/0269029 A1
(43) Pub. Date: Sep. 2, 2021

(54) Group of Vehicles, Method for Operating the Group of Vehicles, Computer Program and Computer-Readable Storage Medium

(71) Applicant: Continental Automotive GmbH, Hannover (DE)

(72) Inventor: Günter Anton Fendt, München (DE)

(73) Assignee: Continental Automotive GmbH, Hannover (DE)

(21) Appl. No.: 17/255,753

(22) PCT Filed: Apr. 26, 2019
(86) PCT No.: PCT/EP2019/060818

§ 371 Date: Dec. 23, 2020

(30) Foreign Application Priority Data
Jun. 26, 2018 (DE) 10 2018 210 371.2

(51) Int. Cl. B60W 30/16; B60W 10/20; B60W 60/00; G08G 1/00

(52) U.S. Cl. CPC B60W 30/16; G08G 1/22; B60W 60/001; B60W 10/20

(57) ABSTRACT

Various embodiments include a group of vehicles comprising: a following vehicle; and a leading vehicle following a trajectory. The following vehicle includes a driver assistance system providing autonomous tracking behind on a trajectory of the leading vehicle. The trajectory defines a target steering angle transmitted to the driver assistance system from the leading vehicle to the following vehicle. The following vehicle has an actual steering angle occurring as a result of executing the target steering angle. A detection device senses a steering angle deviation between the leading vehicle and the following vehicle. A processing unit generates a corrective actuating signal to correct the actual steering angle if there is a steering angle deviation.

### CROSS-REFERENCE TO RELATED APPLICATIONS

This application is a U.S. National Stage Application of International Application No. PCT/EP2019/060818 filed Apr. 26, 2019, which designates the United States of America, and claims priority to DE Application No. 10 2018 210 371.2 filed Jun. 26, 2018, the contents of which are hereby incorporated by reference in their entirety.

### TECHNICAL FIELD

The present disclosure relates to operating vehicles. Various embodiments of the teachings herein may include a group of vehicles with at least one following vehicle and a leading vehicle, the at least one following vehicle having a driver assistance system, the driver assistance system making the at least one following vehicle autonomously track behind on the trajectory of a leading vehicle in the group, methods for operating the group of vehicles, computer programs, and/or computer-readable storage media.

### BACKGROUND

In a group of vehicles in which autonomously driving vehicles communicate both with an infrastructure and with other vehicles, it is necessary to make the driving characteristics of the individual vehicles match one another and to coordinate the vehicles with one another. The information sent by the vehicles by vehicle-to-X communication or vehicle-to-vehicle communication usually includes at least one absolute position, one absolute speed and information about the direction of travel, for example the steering angle.

U.S. Pat. No. 5,781,119 describes a vehicle guidance system that allows a multiplicity of vehicles to travel in line. The vehicle guidance system comprises a front-running vehicle with a sensor unit for detecting a relative deviation of the front-running vehicle from a baseline of a road; with a calculation unit for calculating control variables on the basis of the detected relative deviation to allow the front-running vehicle to travel along the baseline; with a transmitter for transmitting the control variable data calculated by the calculating means to a vehicle following the front vehicle; with a receiver for receiving the control variable data from the transmitter; with a storage unit for storing the control variable data received via the receiver; and with a controller for determining a correction amount on the basis of the received control variable data when the vehicle following behind reaches a position in which the front vehicle has sent the control variable data, the following vehicle being controlled on the basis of the correction amount.

### SUMMARY

The teachings of the present disclosure include methods and systems for improving the driving characteristics of the individual vehicles in the group in relation to one another. For example, some embodiments include a group of vehicles with at least one following vehicle (2) and a leading vehicle (1), the at least one following vehicle (2) having a driver assistance system (3), the driver assistance system (3) making the at least one following vehicle (2) autonomously track behind on the trajectory of a leading vehicle (1) in the group, with a target steering angle, which is transmitted to the driver assistance system (3) from the leading vehicle (1) for the at least one following vehicle (2) to track behind along the trajectory of the leading vehicle (1), and with an actual steering angle, which occurs as a result of executing the target steering angle in the at least one following vehicle (2), characterized in that a detection device (4) is provided for detecting a steering angle deviation between a vehicle in the group driving ahead and the at least one following vehicle (2), and a processing unit is provided for generating a corrective actuating signal to correct the actual steering angle if there is a steering angle deviation.

In some embodiments, the detection device (4) is designed as a camera, in particular a front camera.

In some embodiments, the camera generates image signals for a significant rear area of the vehicle in the group driving ahead, the significant rear area comprising at least one track width between the rear tires.

In some embodiments, a determination of the steering angle deviation is provided, while taking into account a time delay (Δt) as a function of the vehicle speed (v) and the distance (a) from the vehicle in the group driving ahead.

In some embodiments, the time delay (Δt) is that time which is necessary for the at least one following vehicle (2) tracking behind to have reached the trajectory reference point (12) of the vehicle in the group driving ahead at which the at least one following vehicle (2) made to track behind has detected the target steering angle.

In some embodiments, steering angle sensors are provided.

In some embodiments, a check as to whether the steering angle introduced by means of a steering wheel or an actuator coincides with the resulting steering angle of rotation of a chassis is provided by means of the steering angle sensors.

In some embodiments, at least one first steering angle sensor for detecting the steering wheel position and at least one second steering angle sensor for detecting a wheel lock are provided.

In some embodiments, in the event of a malfunction of at least one of the steering angle sensors, it is provided that driving in the group is ended or acceptance to drive in the group is refused.

In some embodiments, the steering angle sensors have steering angle tolerances, the steering angle tolerances having a lower threshold value when driving in a group than in an operating mode as an autonomous single vehicle or in a manual operating mode.

As another example, some embodiments include a method for operating a group of vehicles with at least one following vehicle (2) with a driver assistance system (3) and a leading vehicle (1), the driver assistance system making the following vehicle (2) autonomously track behind on the trajectory of a leading vehicle (1) in the group, characterized by: providing a target steering angle, which is transmitted to the driver assistance system from the leading vehicle (1) for the at least one following vehicle (2) to track behind along the trajectory of the leading vehicle (1), setting an actual steering angle as a result of executing the target steering angle in the at least one following vehicle (2), detecting a steering angle deviation between a vehicle in the group driving ahead and the at least one following vehicle (2) by a detection device, and generating a corrective actuating signal by a processing unit for correcting the actual steering angle when there is a steering angle deviation.

In some embodiments, image signals for a significant rear area of the vehicle in the group driving ahead are generated by a camera, the significant rear area comprising at least one track width between the rear tires.

In some embodiments, the steering angle deviation is determined while taking into account a time delay (Δt) as a function of the vehicle speed (v) and the distance (a) from the vehicle in the group driving ahead.

In some embodiments, steering angle tolerances are formed by steering angle sensors, the steering angle tolerances being set with a lower threshold value when driving in a group than in an operating mode as an autonomous single vehicle or in a manual operating mode.

As another example, some embodiments include a computer program which is designed to carry out a method as described herein.

As another example, some embodiments include a computer-readable storage medium comprising instructions which, when executed by a computer, cause the computer to perform a method as described herein.

### BRIEF DESCRIPTION OF THE DRAWINGS

Further features, properties, and advantages of various embodiments of the teachings herein emerge from the following description with reference to the attached figures, in which, schematically:

FIG. 1 shows a following vehicle incorporating teachings of the present disclosure;

FIG. 2 schematically shows a method incorporating teachings of the present disclosure;

FIG. 3 shows a group of vehicles with the following vehicle and a leading vehicle in plan view incorporating teachings of the present disclosure;

FIG. 4 shows a group of vehicles in operation incorporating teachings of the present disclosure;

FIG. 5 shows a method for checking the steering angle sensors incorporating teachings of the present disclosure; and

FIG. 6 shows a method for checking the steering angle sensors incorporating teachings of the present disclosure.

### DETAILED DESCRIPTION

Various embodiments of the teachings herein include a group of vehicles with at least one following vehicle and a leading vehicle, the at least one following vehicle having a driver assistance system, the driver assistance system making the following vehicle autonomously track behind on the trajectory of a leading vehicle in the group, with a target steering angle, which is transmitted to the driver assistance system from the leading vehicle for the at least one following vehicle to track behind along the trajectory of the leading vehicle, and with an actual steering angle, which occurs as a result of executing the target angle in the at least one following vehicle.

In some embodiments, there a detection device for detecting a steering angle deviation between a vehicle in the group driving ahead and the at least one following vehicle, and a processing unit is provided for generating a corrective actuating signal to correct the actual steering angle if there is a steering angle deviation. The steering angle deviation in this case describes a lateral offset (sideways offset) of the following vehicle in relation to the vehicle in the group driving ahead or the lateral offset of the following vehicle from the longitudinal axis of the vehicle in the group driving ahead.

The steering angle of a vehicle is used for lateral guidance of the motor vehicle. Lateral guidance here is a steering activity that is carried out which guides the vehicle in such a way that it follows the trajectory of the leading vehicle with a permitted error tolerance. The steering angle can be set by the steering wheel position or a steering actuator. The steering angle may be measured by steering wheel angle sensors which detect a steering wheel position as well as the resulting wheel lock.

In this disclosure, a following vehicle tracking behind means a vehicle that is autonomously or automatically tracking behind in the trail of a leading vehicle, the leading vehicle by contrast being controlled for example by a driver and/or being operated in autonomous or partially autonomous driving mode (not autonomously following a leading vehicle driving ahead). In other words, a following vehicle is autonomously controlled by the driver assistance system as a following vehicle in the group, the expression “on the trail of a leading vehicle” not to be taken literally, but to be understood as meaning that a following vehicle follows a leading vehicle or a vehicle driving ahead within a procession/convoy.

In some embodiments, in order to achieve an efficiently cohesive group of vehicles, in certain driving scenarios, for example a jointly performed change of lane when driving on a freeway, the individual vehicles in the group must be guided in a simultaneously acting manner. In this case, the longitudinal and lateral guidance commands do not have to be performed sequentially, but synchronously with all the vehicles in the group involved, in order to be able to guide the vehicles in the group in a compactly grouped-together manner. The vehicles in the group must perform the necessary steering movement by introducing the steering angle synchronously, here at the same time. The synchronous introduction of the same steering angle is necessary for a match of the following vehicles made to follow on the trail of the leading vehicle.

However, the setting of a steering angle in a vehicle is subject to certain tolerances. In some embodiments, due to the system-related tolerances there are and the execution of the specified target steering angle by the following vehicles, after a jointly performed change of lane the following vehicles no longer necessarily drive on the trajectory or trail specified by the leading vehicle, but laterally offset in relation to one another. In this case, the amount of lateral offset that occurs is determined by the tolerance of the steering angles that differ from one another.

The steering angle deviation between the vehicle in the group driving ahead and the following vehicle can be detected by the detection device. In this case, this detection may be carried out at periodically recurring intervals or permanently or over a certain section of the route. A single detection is also possible. If there is a steering angle deviation, various measures can be taken using the corrective actuating signal. This may be for example an automatic correction of the actual steering angle with the aid of the corrective actuating signal, and also other emergency measures, for example a warning or a request to the driver for manual correction. Before an automatic correction is carried out or an emergency measure is carried out in the following vehicle, this correction may be verified in advance by means of a plausibility check, in that the detection device in the following vehicle is used to check the tracking, i.e. that the leading vehicle or the vehicle driving ahead is keeping on track and, if a “questionable” track trajectory of the leading vehicle or the vehicle driving ahead is found, an automatic correction is prevented and instead only an emergency measure or a manual correction is carried out in the following vehicle.

The corrective actuating signal generated when there is a steering angle deviation may be introduced by correcting the steering wheel position, the introduction taking place for example by means of superposition steering. The corrective actuating signal may be used to compensate for the lateral offset as a result of steering angle tolerances. The lateral offset of the following vehicles in relation to one another can be eliminated by the corrective actuating signal, whereby, after a jointly performed change of lane, the following vehicles drive again on the trajectory or trail specified by the leading vehicle. If the lateral offset of the successive vehicles is below a specified correction threshold value, that is to say if the steering angle deviation is below a specified correction threshold value, it is possible to dispense with a correction. In this case, the correction threshold value may for example be taken from a database which has been defined in advance or it may have been established in advance.

In some embodiments, the detection device is designed as a camera, in particular a front camera. The front camera may be designed as an electronic camera which detects the significant rear area of the vehicle in the group driving ahead, that is to say easy to evaluate in terms of images, the significant rear area comprising at least one track width between the rear tires. The camera may generate image signals for the significant rear area of the vehicle in the group driving ahead. The detection of the rear area of the vehicle in the group driving ahead takes place here in particular in order to determine the relative location, that is to say a position, of the vehicle in the group driving ahead with respect to the lane or the roadway (driving trajectory), with the track width for example being included as an evaluation criterion for the relative location of the vehicle in the group driving ahead with respect to the lane or the roadway (driving trajectory). The lateral offset, that is to say the steering angle deviation, of the vehicle in the group driving ahead can be calculated from the image signals generated.

In some embodiments, a determination of the steering angle deviation is provided, while taking into account a time delay as a function of the vehicle speed and the distance from the vehicle in the group driving ahead. The time delay in this case corresponds to that time which is necessary for the following vehicle tracking behind to have reached the trajectory reference point or track reference point of the vehicle in the group driving ahead at which the following vehicle made to track behind has detected the target steering angle. This means that the target steering angle and the actual steering angle are compared with one another for the same trajectory reference point or track reference point. As a result, a more accurate determination of the lateral offset of the successive vehicles in the group is possible.

The time delay is the quotient of the speed of the vehicle in the group driving ahead and the distance between the vehicle in the group driving ahead and the following vehicle. In this case, due to the mode of operation in the group, the speed of the vehicle in the group driving ahead may be identical to the speed of the following vehicle.

In some embodiments, there are steering angle sensors. The term steering angle sensors means both sensors for detecting the steering wheel position and sensors for detecting the resulting wheel lock. The steering angle sensors may be designed as rotary rotation angle sensors, which are mostly arranged on the steering column, on the steering pinion directly or on a connected input shaft. In some embodiments, the steering angle sensors may be both so-called multi-turn sensors, which measure the absolute steering angle over more than one rotation from stop to stop, or single-turn sensors or else as incremental angle sensors.

A check as to whether the steering angle introduced by means of a steering wheel or an actuator coincides with the resulting steering angle of rotation of a chassis is preferably provided by means of the steering angle sensors. Such a check may be carried out on all of the vehicles in the group.

In some embodiments, at least one first steering angle sensor for detecting the steering wheel position and at least one second steering angle sensor for detecting a wheel lock are provided for this purpose. If the steering angle sensors or one of the steering angle sensors show(s) a malfunction, it is not possible to operate this vehicle in a group.

In some embodiments, the actual steering angle is determined by means of steering angle sensors. The steering angle can be set by a steering wheel position or a steering actuator.

In some embodiments, in the event of a malfunction in at least one of the steering angle sensors, driving in the group is ended or acceptance to drive in the group is refused. Malfunctions, which are intended here also to include irregularities, are understood as meaning that the steering angle tolerance deviation, that is to say the steering angles introduced with the resulting steering angles of rotation of the chassis, are above a specified threshold value.

The steering angle sensors may have steering angle tolerances, the steering angle tolerances having a lower threshold value when driving in a group than in an operating mode as an autonomous single vehicle or in a manual operating mode. The vehicle is operated autonomously or partially autonomously as a single vehicle if it is not controlled to autonomously follow a leading vehicle driving ahead. As a result, the approval to drive in the group is only issued when the standard threshold values have been lowered and there is no malfunction. This improves the “driving in a group” mode of operation and reduces the risk of accidents.

In some embodiments, there is a method for operating a group of vehicles with at least one following vehicle with a driver assistance system and a leading vehicle, the driver assistance system making the following vehicle autonomously track behind on the trajectory of a leading vehicle in the group, with the following steps:
providing a target steering angle, which is transmitted to the driver assistance system from the leading vehicle, for the at least one following vehicle to track behind along the trajectory of the leading vehicle,
setting an actual steering angle, as a result of executing the target steering angle in the at least one following vehicle,
detecting a steering angle deviation between a vehicle in the group driving ahead and the at least one following vehicle by a detection device, and
generating a corrective actuating signal by a processing unit for correcting the actual steering angle when there is a steering angle deviation.

Image signals for a significant rear area of the vehicle in the group driving ahead may be generated by a camera, the significant rear area comprising at least one track width between the rear tires. The steering angle deviation may be determined while taking into account a time delay as a function of the vehicle speed and the distance from the vehicle in the group driving ahead.

In some embodiments, a check as to whether the steering angle introduced by means of a steering wheel or an actuator coincides with the resulting steering angle of rotation of a chassis is performed by means of the steering angle sensors. In the event of a malfunction of at least one of the steering angle sensors, driving in the group is ended or acceptance to drive in the group may be refused.

In some embodiments, the steering angle sensors form steering angle tolerances, the steering angle tolerances being set with a lower threshold value when driving in a group than in an operating mode as an autonomous single vehicle or in a manual operating mode.

In some embodiments, there is a computer program comprising instructions which, when the program is executed by the computer, cause the computer to perform the methods as described herein. The computer program then subsequently adds a method as described to a vehicle. This subsequent addition can for example be carried out externally by the vehicle manufacturer.

In some embodiments, there is a computer-readable storage medium comprising instructions which, when executed by the computer, cause the computer to perform the methods as described herein.

Although the teachings of the present disclosure have been described and illustrated in more detail by means of the exemplary embodiments, the scope of the disclosure is not limited by the disclosed examples. Variations thereof may be derived by a person skilled in the art without departing from the scope of protection of the disclosure.

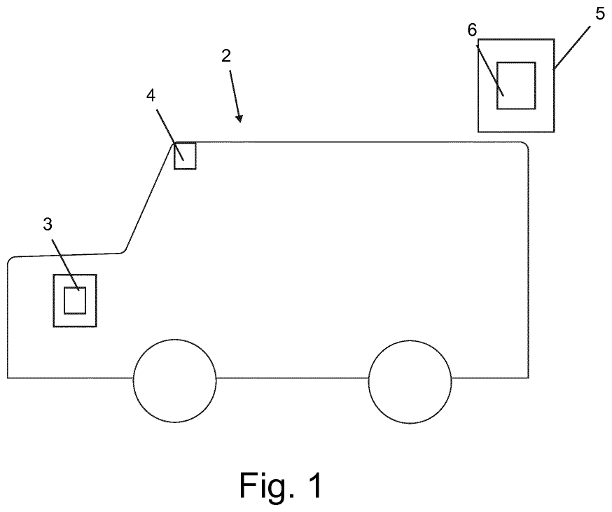

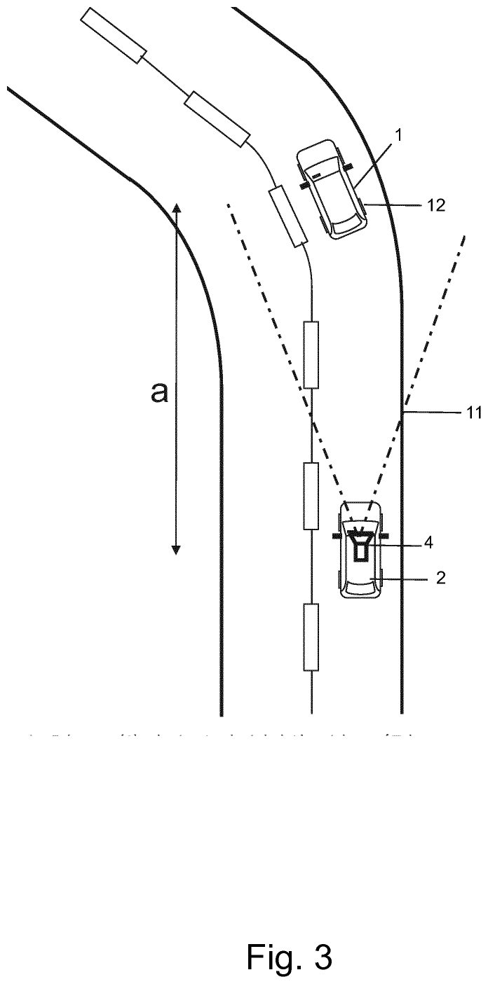

FIG. 1 shows a following vehicle 2 with a driver assistance system 3 with a processing unit (not shown) incorporating teachings of the present disclosure. The following vehicle 2 further comprises a detection device 4, here for example a front camera, for detecting the significant rear area of the vehicle in the group 1 driving ahead (FIG. 3), the significant rear area comprising at least the track width between the rear tires. The detection device generates image signals from this in order to determine the relative location/position of the vehicle in the group 1 driving ahead (FIG. 3) with respect to the lane/roadway (driving trajectory).

The detection of the relative location/position of the vehicle in the group 1 driving ahead (FIG. 3) with respect to the lane/roadway takes place over a certain period of time for a certain section of a driving trajectory. A section of a driving trajectory that contains a bend/curve may be used here. In order for the vehicle in the group 1 driving ahead (FIG. 3) to be able to drive along the section of this driving trajectory on track, a time sequence of “steering movements” must be performed in the vehicle in the group driving ahead (FIG. 3), these steering movements being able to be described as a time function with corresponding steering angle parameters.

These steering angle parameters as a function are made available to the following vehicle 2 by the vehicle in the group 1 driving ahead (FIG. 3) via car-to-car communication in order that the following vehicle 2 can execute these steering angle parameters as a function (autonomously) when the following vehicle 2 travels along the corresponding section of the driving trajectory at a subsequent time. If, before passing the bend/curve, the following vehicle 2 has followed the vehicle in the group 1 driving ahead (FIG. 3) without any lateral offset in relation to it and there are no deviations in the steering angle sensors/steering angle tolerances, the following vehicle 2 must again be aligned exactly (without lateral offset) in relation to the vehicle in the group 2 driving ahead after passing the bend/curve. If, however, after passing the bend/curve, a lateral offset in relation to the vehicle in the group 1 driving ahead (FIG. 3) that was not present before passing the bend/curve is found by the detection device 4, then a steering angle deviation is derived from this, the size of which can be determined on the basis of the distance traveled.

Thus, from the generated sequential image signals of an, in particular curved, section of a driving trajectory and a vehicle in the group 1 driving ahead (FIG. 3), a relative deviation between/with respect to the vehicle in the group 1 driving ahead (FIG. 3) and the following vehicle 2 can be determined, or a potential lateral offset can be determined, that is to say the steering angle deviation can be calculated with respect to the vehicle in the group 2 driving ahead.

On the basis of the steering angle deviation, or the resulting lateral offset with respect to the vehicle in the group 1 driving ahead (FIG. 3) in relation to the longitudinal axis of the following vehicle 2, the corrective actuating signal that is used to correct the steering wheel position is generated. This makes it possible to compensate for the lateral offset that is caused by steering angle tolerances. The correction may already take place while the bend/curve is being passed, in order that, if there is a steering angle tolerance, in particular a relatively great tolerance, there is no excessive, safety-critical, lateral offset over time, for example drifting off track, of the following vehicle 2 while driving around the curve or while passing the bend/curve.

In addition, an evaluation unit 5 may be provided, for storing the steering angle deviation and the corrective actuating signal. The evaluation unit 5 is in this example arranged outside the following vehicle 2. The evaluation unit 5 may have a non-volatile memory 6 for storing the recorded data. This can be used to create an expert system or a database. By means of this expert system or database, the method for calculating the steering angle deviation from the image signals can be more easily calculated by machine learning or by some other AI method. In some embodiments, the evaluation unit 5 receives and sends data wirelessly.

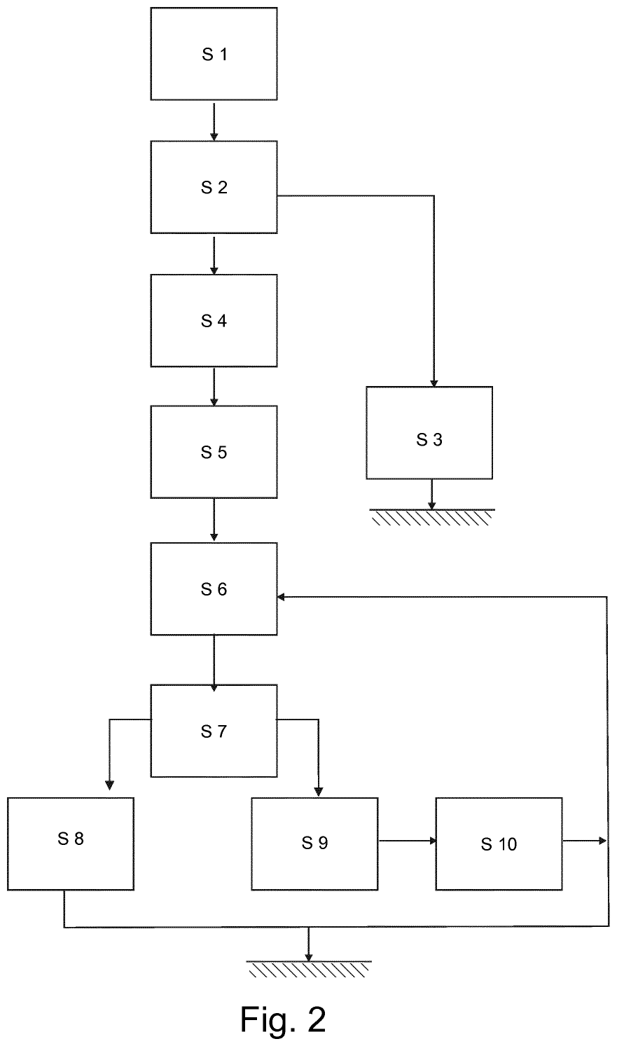

FIG. 2 shows a method incorporating teaching of the present disclosure in a first embodiment. Here, in a first step S1, the following vehicle 2 (FIG. 1) is put into operation by the driver. In a second step S2, it is checked whether the steering angle introduced by means of a steering wheel or an actuator coincides with the resulting steering angle of rotation of a chassis, or whether the steering angle sensors have malfunctions. For this purpose, the vehicle-internal interfaces of the steering angle sensors and the steering angle sensors themselves are checked.

At least one first steering angle sensor for detecting the steering wheel position and at least one second steering angle sensor for detecting a wheel lock are in this case provided as steering angle sensors. If there is a malfunction of at least one of the steering angle sensors or the interface, a driving-in-a-group mode is not possible. In a step S3, a warning is output and/or possibly further emergency measures are initiated.

If there is no malfunction, a driving-in-a-group mode is possible. For this purpose, a leading message sent from a leading vehicle 1 (FIG. 3) via vehicle-to-X communication or vehicle-to-vehicle communication, indicating readiness for autonomous tracking of following vehicles, is accepted in a step S4, and a group is formed. By means of vehicle-to-X communication or vehicle-to-vehicle communication, target steering angles are transmitted to the at least one following vehicle 2 (FIG. 1) in a step S5. On the basis of these target steering angles, an actual steering angle or a time sequence of actual steering angles is set by the following vehicle 2 (FIG. 1).

By means of the detection device 4 (FIG. 1), the rear area of the vehicle in the group driving ahead, for example here the leading vehicle 1 (FIG. 3), is detected in a step S6. The camera generates image signals from the rear area of the leading vehicle 1 (FIG. 3). The steering angle deviation, here the lateral offset of the leading vehicle 1 (FIG. 3) in relation to the longitudinal axis of the following vehicle 2 (FIG. 1), is calculated in a step S7 by electronic image evaluation of the image signals.

The steering angle deviation is determined while taking into account a time delay Δt (FIG. 3) as a function of the vehicle speed v (FIG. 3) and the distance a (FIG. 3) from the leading vehicle 1 (FIG. 3). The time delay Δt in this case corresponds to that time which is necessary for the following vehicle 2 tracking behind (FIG. 1) to have reached the trajectory reference point 12 (FIG. 3) or track reference point of the leading vehicle 1 (FIG. 1) at which the following vehicle 2 tracking behind (FIG. 1) has detected the target steering angle. This means that the target steering angle and the actual steering angle are compared with one another at the same trajectory reference point 12 (FIG. 3) or track reference point. As a result, a more accurate determination of the lateral offset of the successive vehicles in the group is possible.

If there is no steering angle deviation or if the steering angle deviation is below a specified correction threshold value, then in a step S8 the driving in a group is continued on the basis of the target steering angle transmitted by the leading vehicle 1 (FIG. 3). The method can be repeated for a short section of the route or at periodic intervals, starting with step S6.

If a steering angle deviation is found, a corrective actuating signal is generated in a step S9 on the basis of the image signals of the detection device 4 (FIG. 1) and is used to correct the actual steering angle. The corrective actuating signal can be introduced for example via a corrected steering wheel position.

This compensates for the lateral offset that is caused by the steering angle tolerance. In the subsequent driving in a group, accordingly first the target steering angle transmitted by the leading vehicle 1 (FIG. 3) is set and then the corrective actuating signal is applied to the actual steering angle, the actual steering angle being obtained by applying the target steering angle in the following vehicle 2 (FIG. 1). In addition, depending on the degree of deviation, further emergency measures may be initiated in a step S10.

The method can be repeated in step S6 at periodic intervals up to the end of the driving in a group.

FIG. 3 shows a group of vehicles with the following vehicle 2 and a leading vehicle 1 in a plan view. The detection device 4 detects the rear area of the leading vehicle 1 during the driving in a group. The detection device 4 is designed here as a camera and has a recording angle 11.

The steering angle deviation is determined while taking into account a time delay Δt as a function of the vehicle speed v m/s and the distance a from the leading vehicle 1. In particular, the time delay Δt is the quotient of the speed v in m/s of the leading vehicle 1 and the distance a between the leading vehicle 1 and the following vehicle 2. In this case, the speed v of the leading vehicle 1 is essentially identical to the speed v of the following vehicle 2. This means that the actual steering angle is compared with the target steering angle of the leading vehicle 1 at the same trajectory reference point 12.

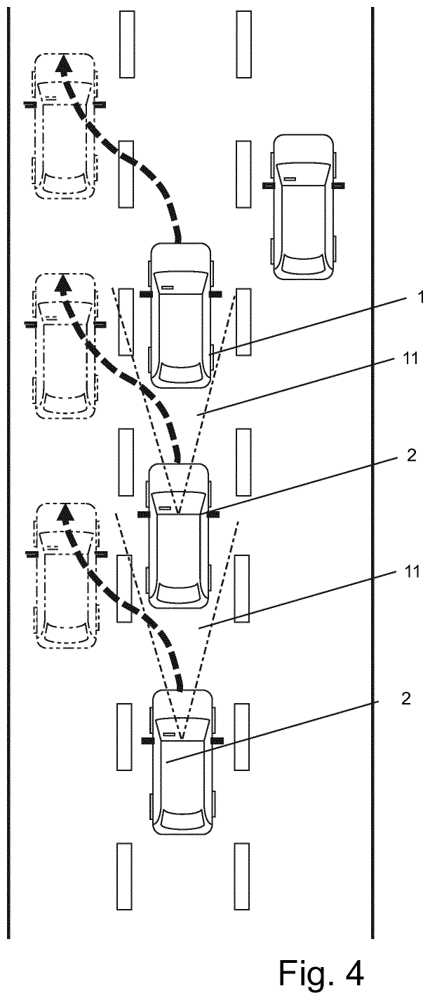

FIG. 4 shows a group of vehicles consisting of a leading vehicle 1 and two successive following vehicles 2 during an overtaking maneuver, for example when changing lanes. Here it is necessary that the longitudinal and lateral guidance commands are not executed sequentially, but synchronously with all the vehicles in the group, in order that the group can be made to proceed in close order. The methods and systems described herein allow steering angle deviations that occur after such a maneuver to be eliminated.

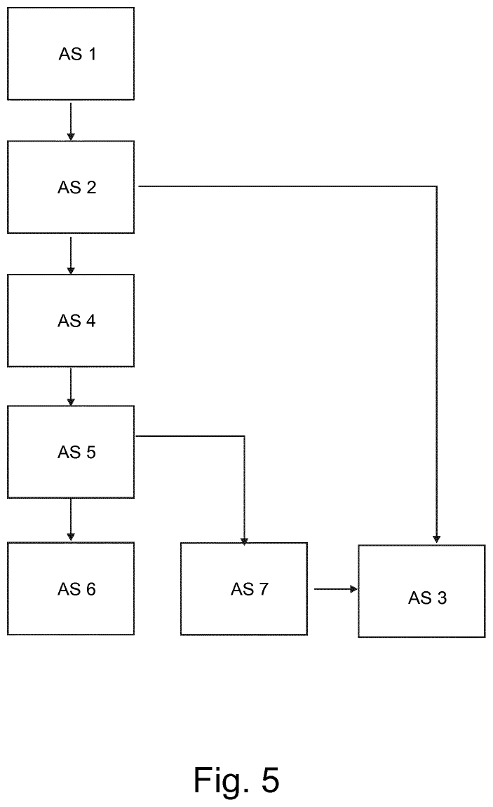

FIG. 5 shows a method for checking the steering angle sensors in a first embodiment incorporating teachings of the present disclosure. In this case, steering angle sensors are understood as meaning both sensors for detecting the steering wheel position and sensors for detecting the resulting wheel lock. Here, in a first step AS 1, a vehicle is put into operation by the driver. In a second step AS 2, it is ascertained whether the vehicle is to be operated in an autonomous group operation or as a single vehicle in an autonomous/partially autonomous mode of operation or in a manual mode of operation.

If the vehicle is operated as a single vehicle in an autonomous/partially autonomous operating mode or in a manual operating mode, the vehicle's own steering angle sensors are not checked and the vehicle can start its journey in a step AS 3 as a partially autonomous or autonomous single vehicle or manually operated single vehicle.

If the vehicle is operated as a following vehicle 2 (FIG. 1) in a group in a step AS 4, first the threshold values for the steering angle tolerances are re-set. In this case, these threshold values are lower than the threshold values for a partially autonomous/autonomous or manual mode of operation. In a step AS 5, it is checked whether the steering angle sensors have an irregularity or a malfunction. In this case, a malfunction or irregularity is understood as meaning that the steering angle introduced into the steering system by means of the steering wheel and the resulting steering angle of rotation of the chassis are above a threshold value (for example too sensitive/too responsive) or below a threshold value (for example too insensitive/too unresponsive). The interfaces of the steering angle sensors, which can likewise have irregularities or malfunctions, for example can return faulty logs, are likewise checked.

If there are no malfunctions or irregularities of the steering angle sensors, then in a step AS 6 driving operation as a vehicle in a group is enabled.

If an irregularity or a malfunction is found in one of the steering angle sensors, driving operation as a vehicle in a group is not enabled in a step AS 7 and the vehicle is transferred to step AS 3, that is to say the vehicle is further controlled manually or in a partially autonomous/autonomous mode of operation.

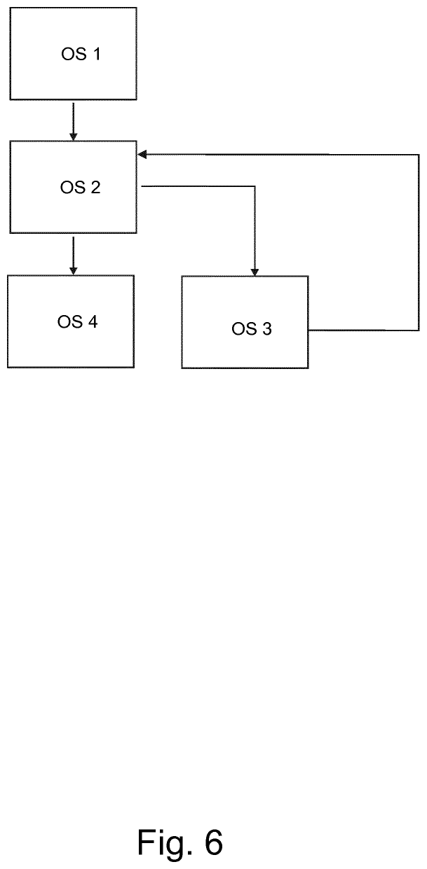

FIG. 6 shows a further method for checking the steering angle sensors in a second embodiment incorporating teachings of the present disclosure. Here, the following vehicle 2 is operated in a first step OS 1 in a group operating mode. The following vehicle (FIG. 1) is therefore operated with newly set threshold values for the steering angle tolerance. In this case, these threshold values are lower than the threshold values for a partially autonomous/autonomous or manual mode of operation. In a step OS 2, it is checked whether the steering angle sensors or one of the steering angle sensors has/have an irregularity or a malfunction. Likewise checked in step OS 2 are the interfaces to the steering angle sensors, which can likewise have irregularities or malfunctions, for example can return faulty logs.

If there are no malfunctions or irregularities of the steering angle sensors, then in a step OS 3 driving operation as a vehicle in a group is continued and the method begins again with OS 2. In this case, the method can keep being restarted periodically. The method ends when driving as a following vehicle 2 (FIG. 1) ends.

If an irregularity or a malfunction is found in one of the steering angle sensors, further driving operation as a vehicle in a group is not enabled and the vehicle is further controlled manually or in a partially autonomous/autonomous mode of operation in step OS 4.

### LIST OF REFERENCE SIGNS

1 Leading vehicle
2 Following vehicle
3 Driver assistance system
4 Detection device
5 Evaluation unit
6 Non-volatile memory
11 Recording angle
12 Trajectory reference point
a Distance
v Vehicle speed
Δt Time delay
S, AS, OS Method steps

What is claimed is:

1. A group of vehicles comprising:
a following vehicle; and
a leading vehicle following a trajectory;
wherein the following vehicle includes a driver assistance system providing autonomous tracking behind on the trajectory of the leading vehicle;
wherein the trajectory defines a target steering angle transmitted to the driver assistance system from the leading vehicle to the following vehicle; and
wherein the following vehicle has an actual steering angle occurring as a result of executing the target steering angle;
a detection device senses a steering angle deviation between the leading vehicle and the following vehicle; and
a processing unit generates a corrective actuating signal to correct the actual steering angle if there is a steering angle deviation.

2. The group of vehicles as claimed in claim 1, wherein the detection device comprises a camera.

3. The group of vehicles as claimed in claim 2, wherein the camera generates image signals for a rear area of the leading vehicle, the rear area comprising at least one track width between the rear tires.

4. The group of vehicles as claimed in claim 1, wherein the processing unit determines the steering angle deviation, and accounts for a time delay as a function of vehicle speed and a distance between the leading vehicle and the following vehicle.

5. The group of vehicles as claimed in claim 4, wherein the time delay represents a time necessary for the following vehicle to reach a trajectory reference point of the leading vehicle at which the following vehicle detects the target steering angle.

6. The group of vehicles as claimed in claim 1, further comprising steering angle sensors for each vehicle.

7. The group of vehicles as claimed in claim 6, wherein the processing unit checks whether the steering angle introduced by means of a steering wheel or an actuator coincides with the resulting steering angle of rotation of a chassis using the steering angle sensors.

8. The group of vehicles as claimed in claim 6, further comprising a first steering angle sensor for detecting the steering wheel position and a second steering angle sensor for detecting a wheel lock.

9. The group of vehicles as claimed in claim 6, wherein, in the event of a malfunction of any steering angle sensor, driving in the group is ended or acceptance to drive in the group is refused.

10. The group of vehicles as claimed in claim 6, wherein each of the steering angle sensors includes a respective steering angle tolerance with a lower threshold value when driving in a group than in an operating mode as an autonomous single vehicle or in a manual operating mode.

11. A method for operating a group of vehicles including a following vehicle having a driver assistance system and a leading vehicle, the driver assistance system operating the following vehicle to track behind the leading vehicle, the method comprising:
transmitting a target steering angle to the driver assistance system from the leading vehicle for the following vehicle to track behind along a trajectory of the leading vehicle;
setting an actual steering angle in the following vehicle based on the target steering angle;
detecting a steering angle deviation between the leading vehicle and the following vehicle using a detection device; and
generating a corrective actuating signal with a processing unit for correcting the actual steering angle if there is a steering angle deviation.

12. The method for operating a group of vehicles as claimed in claim 11, further comprising evaluating image signals for a rear area of the lead vehicle generated by a camera, the rear area comprising at least one track width between rear tires of the lead vehicle.

13. The method for operating a group of vehicles as claimed in claim 11, wherein the steering angle deviation is determined based on a time delay, a vehicle speed, and a distance between the lead vehicle and the following vehicle.

14. The method for operating a group of vehicles as claimed in claim 11, wherein steering angle tolerances are formed by steering angle sensors, the steering angle tolerances having a lower threshold value when driving in a group than in an operating mode as an autonomous single vehicle or in a manual operating mode.

15-16. (canceled)
